(19) United States
(12) Patent Application Publication
(10) Pub. No.: US 2010/0156589 A1
(43) Pub. Date: Jun. 24, 2010

(54) Resistor and method for making a resistor

(75) Inventor: Samuel Kuo, Taipei Hsien (TW)

Correspondence Address: POSZ LAW GROUP, PLC, 12040 SOUTH LAKES DRIVE, SUITE 101, RESTON, VA, 20191, US

(73) Assignee: TY-OHM ELECTRONIC WORKS CO., LTD., Taipei Hsien (TW)

(21) Appl. No.: 12/318,178

(22) Filed: Dec. 23, 2008

(51) Int. Cl. H01C 1/02; H01C 17/02

(52) U.S. Cl. 338/226; 29/613

(57) ABSTRACT

A resistor having a body, a fuse component, a resistor component, a wire and a cover. The body has a top, a first positioning hole and a second positioning hole being formed in the top of the body. The fuse component is inserted in the first positioning hole. The resistor component is inserted in the second positioning hole. The wire connects the fuse component and the resistor component and is mounted outside the body. The cover is attached to the top of the body around the wire. Therefore, the body of resistor as described may be dried in an oven without damaging the resistor component. A method having steps of forming a body having two positioning holes, drying the body in an oven heated above 130° C., mounting a resistor component and a fuse component respectively in the positioning holes, and covering the positioning holes with an insulating cover.

### BACKGROUND OF THE INVENTION

1. Field of the Invention

The present invention relates to a resistor, especially to an explosion-proof resistor.

2. Description of the Prior Art

With reference to FIG. 7, a conventional resistor is used in a circuit for safely breaking the circuit in high temperature or high voltage for protecting other components in the circuit. To prevent shattered pieces generated in an explosion from destroying nearby components, the conventional resistor comprises a body (20) having an outer frame and two holes (21). The body (20) may be made of cement or ceramic. A fuse component (22) and a resistor component (23) connected with a wire (24) are inserted in the body (20). The fuse component (22) has a terminal (221) penetrating outwards through one of the two holes (21). The resistor component (23) has a terminal (231) penetrating outwards through the other hole (21). By filling the body (20) with cement or ceramic, the body (20) forms a structure for preventing explosion damage.

One way to dry the cement filled in the body (20) is to bake the conventional resistor in an oven at 160° C. Such oven, however, may destroy the fuse component (22) which can only tolerate a temperature under 130° C. In practice, the aforementioned problem is solved by wind-drying the cement to make the conventional resistor. The wind-drying process requires extra space and longer manufacturing time, which result into ineffective production and low output quantity.

To overcome the shortcomings, the present invention provides a resistor to mitigate or obviate the aforementioned problems.

### SUMMARY OF THE INVENTION

The main objective of the invention is to provide a resistor.

The resistor in accordance with the present invention comprises a body, a fuse component, a resistor component, a wire and a cover. The body comprises a top, a first positioning hole and a second positioning hole being formed in the top of the body. The fuse component is inserted in the first positioning hole. The resistor component is inserted in the second positioning hole. The wire connects the fuse component and the resistor component and is mounted outside the body. The cover is attached to the top of the body around the wire. Therefore, the body of resistor as described may be dried in an oven without damaging the resistor component.

The present invention also directs to a method to make the resistor. The method has steps of forming a body having two positioning holes, drying the body in an oven heated above 130° C., mounting a resistor component and a fuse component respectively in the positioning holes, and covering the positioning holes with an insulating cover.

Other objectives, advantages and novel features of the invention will become more apparent from the following detailed description when taken in conjunction with the accompanying drawings.

### BRIEF DESCRIPTION OF THE DRAWINGS

FIG. 1 is a partially exploded perspective view of a resistor in accordance with the present invention;

FIG. 2 is a side view in partial section of the resistor in FIG. 1 covered with a sealing adhesive;

FIG. 3 is a side view in partial section of the resistor in FIG. 1 covered with a lid;

FIG. 4 is a partially exploded perspective view of another embodiment of a resistor in accordance with the present invention;

FIG. 5 is a side view in partial section of the resistor in FIG. 4 covered with a sealing adhesive;

FIG. 6 is a side view in partial section of the resistor in FIG. 4 covered with a lid; and

FIG. 7 is a side view in partial section of a conventional resistor in accordance with the prior art.

### DETAILED DESCRIPTION OF THE PREFERRED EMBODIMENTS

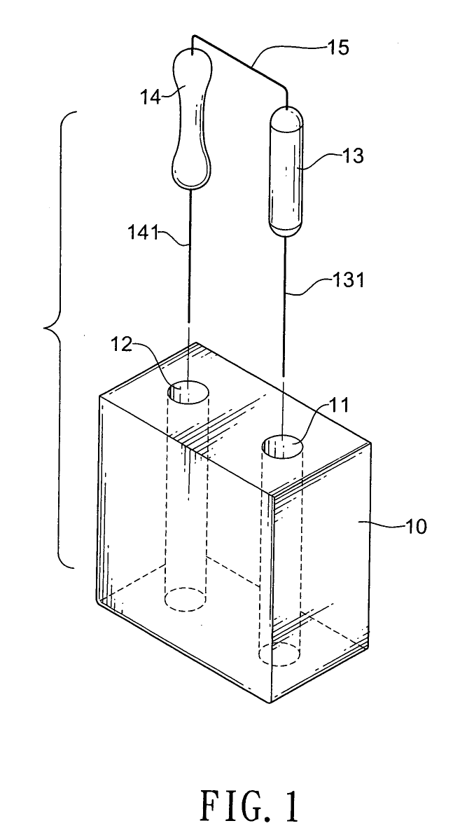

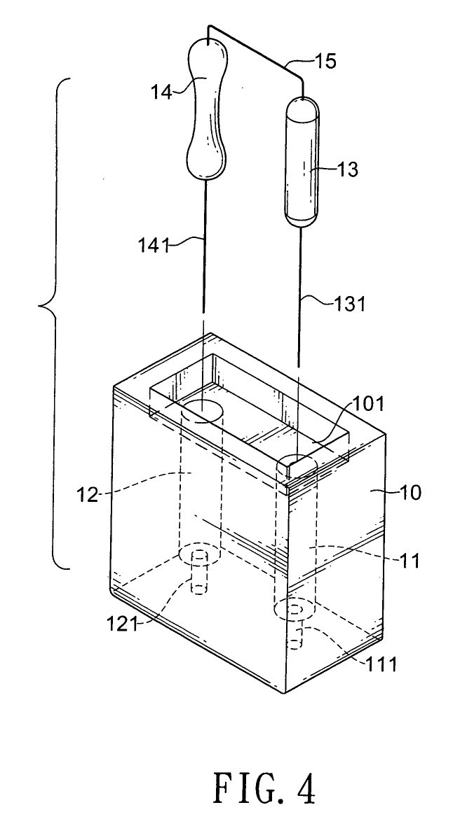

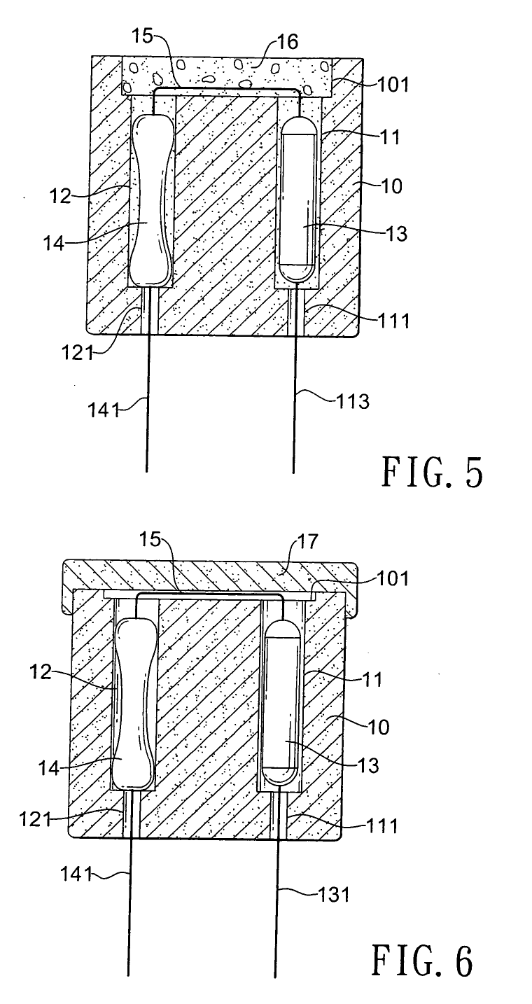

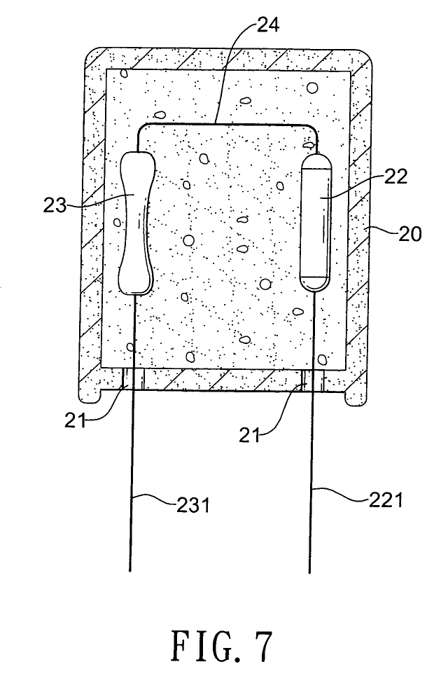

With reference to FIGS. 1 to 4, a resistor in accordance with the present invention comprises a body (10), a fuse component (13), a resistor component (14), a wire (15) and a cover.

The body (10) comprises a top, a bottom, a first positioning hole (11) and a second positioning hole (12), may have a recess (101) and may be cement or ceramic. The positioning holes (11, 12) are formed in the top of the body (10) and may further comprise terminal holes (111, 121). The terminal holes (111, 121) are formed in the bottom of the body (10) and respectively communicate with the positioning holes (11, 12). The recess (101) is formed in the top of the body and communicates with the positioning holes (11, 12). The fuse component (13) is mounted in the first positioning hole (11) and may have a terminal (131) being mounted through the terminal hole (111) of the first positioning hole (11) for electrical connection.

The resistor component (14) is mounted in the second positioning hole (12) and may have a terminal (141) being formed on the resistor component (14) and mounted through the terminal hole (121) of the second positioning hole (12) for electrical connection.

The wire (15) is mounted outside the body (10) and connects the fuse component (13) and the resistor component (14).

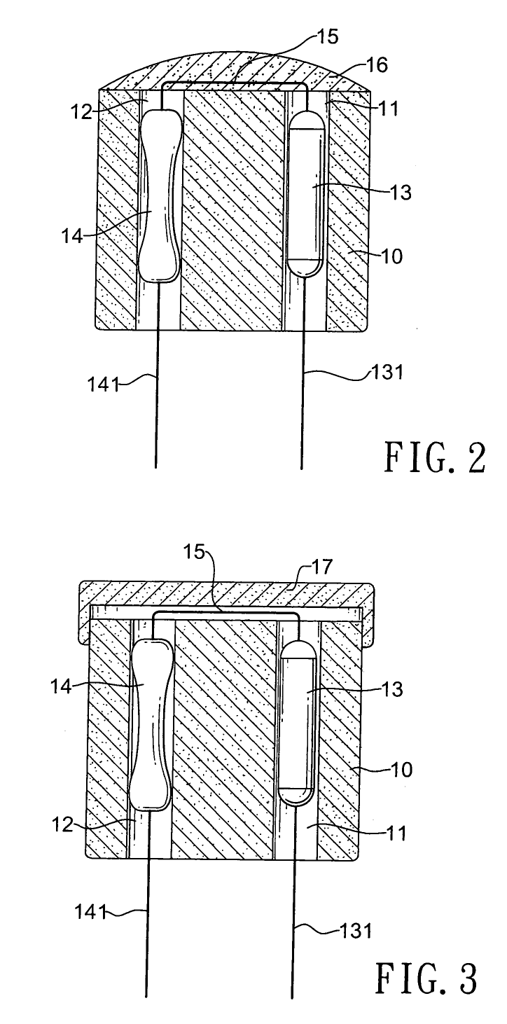

The cover is an insulator attached to the top of the body (10) covers the wire (15) and may be formed in the recess of the body. With further reference to FIGS. 2 and 3, the cover may be a sealing adhesive (16) or a lid (17).

The resistor in accordance with the present invention effectively positions the fuse component (13) and the resistor component (14) in the first positioning hole (11) and the second positioning hole (12). The resistor also provides an effective means for insulating the exposed wire (15). Therefore, the body of resistor as described may be dried in an oven above 130° C. without damaging the resistor component so the resistor can be produced quickly, easily and more cost effectively.

With reference to FIGS. 1 to 3, another aspect of the present invention relates to a method of making a resistor comprising forming a body (10) having two positioning holes (11, 12), drying the body (10) in an oven heated above 130° C., mounting a resistor component (14) and a fuse component (13) respectively in the positioning holes (11, 12) and covering the positioning holes (11, 12) with an insulating cover. The oven may be heated above 160° C.

The body (10) may further comprise a top and a recess (101). The recess (101) is formed in the top of the body (10) and communicating with the positioning holes (11, 12), wherein a wire (15) is mounted in the recess (101). The body (10) may further comprises a bottom, a first positioning hole (11) and a second positioning hole (12). The first positioning hole (11) further comprises a terminal hole (111). The terminal hole (111) is formed in the bottom of the body (10) and communicates with the first positioning hole (11). The second positioning hole (12) further comprises a terminal hole (112). The terminal hole (112) is formed in the bottom of the body (10) and communicates with the second positioning hole (12).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A resistor comprising
a body comprising
a top;
a first positioning hole being formed in the top of the body; and
a second positioning hole being formed in the top of the body;
a fuse component being mounted in the first positioning hole;
a resistor component being mounted in the second positioning hole;
a wire being mounted outside the body and connecting the fuse component and the resistor component; and
a cover being an insulator attached to the top of the body covering the wire.

2. The resistor as claimed in claim 1, wherein the cover is a sealing adhesive covering the wire.

3. The resistor as claimed in claim 1, wherein the cover is a lid covering the wire.

4. The resistor as claimed in claim 1, wherein the body further comprises a recess formed in the top of the body and communicating with the positioning holes, wherein the wire is mounted in the recess.

5. The resistor as claimed in claim 1, wherein
the body further comprises a bottom;
first positioning hole further comprises a terminal hole being formed in the bottom of the body and communicating with the first positioning hole; and
the second positioning hole further comprises a terminal hole being formed in the bottom of the body and communicating with the second positioning hole.

6. The resistor as claimed in claim 5, wherein
the fuse component further comprises a terminal being formed on the fuse component and mounted through the terminal hole of the first positioning hole; and
the resistor component further comprises a terminal being formed on the resistor component and mounted through the terminal hole of the second positioning hole.

7. The resistor as claimed in claim 1, wherein the body is made of cement.

8. The resistor as claimed in claim 1, wherein the body is made of ceramic.

9. A method of making a resistor comprising
forming a body having two positioning holes;
drying the body in an oven heated above 130° C.;
mounting a resistor component and a fuse component respectively in the positioning holes; and
covering the positioning holes with an insulating cover.

10. The method as claimed in claim 9, wherein the body further comprises
a top; and
a recess formed in the top of the body and communicating with the positioning holes, wherein a wire is mounted in the recess.

11. The method as claimed in claim 9, wherein
the body further comprises a bottom;
first positioning hole further comprises a terminal hole being formed in the bottom of the body and communicating with the first positioning hole; and
the second positioning hole further comprises a terminal hole being formed in the bottom of the body and communicating with the second positioning hole.

12. The method as claimed in claim 9, wherein the oven is heated above 160° C.
